(19) United States
(12) Patent Application Publication
(10) Pub. No.: US 2022/0332505 A1
(43) Pub. Date: Oct. 20, 2022

(54) DELIVERY APPARATUS, SYSTEM, METHOD, ELECTRONIC DEVICE AND COMPUTER READABLE STORAGE MEDIUM

(71) Applicant: Rajax Network Technology (Shanghai) Co., Ltd., Shanghai (CN)

(72) Inventors: Wei MIN, Shanghai (CN); Kai WANG, Shanghai (CN); Pei LI, Shanghai (CN); Jinzhong ZHANG, Shanghai (CN); Xiaochao WANG, Shanghai (CN)

(21) Appl. No.: 17/762,985

(22) PCT Filed: Mar. 14, 2020
(86) PCT No.: PCT/CN2020/079411

§ 371 Date: Mar. 23, 2022

(30) Foreign Application Priority Data
Sep. 23, 2019 (CN) 201910901726.5

(51) Int. Cl. B65G 1/137; B65G 1/127; B65D 25/24

(52) U.S. Cl. CPC B65G 1/1373; B65G 1/127; B65D 25/24; B65G 2203/0283

(57) ABSTRACT

A delivery apparatus, a delivery system, a delivery method, an electronic device, and a computer readable storage medium are disclosed. The delivery apparatus includes a movable detachably and electrically connected with a cabin, where the movable chassis is configured to include: a first controller mounted inside the movable chassis, and a moving component mounted at a bottom of the movable chassis and connected with the first controller to drive the movable chassis and the cabin to move to a target position according to an instruction of the first controller; the cabin is configured to have one or more accommodation spaces for accommodating to-be-delivered objects. The technical solution greatly improves the delivery efficiency and reduces the delivery cost.

### CROSS REFERENCE TO RELATED APPLICATIONS

The present application is a U.S. National Phase of International Application Serial No. PCT/CN2020/079411 filed on Mar. 14, 2020, which claims priority to Chinese Patent Application No. 201910901726.5 filed on Sep. 23, 2019. The entire content of the above-referenced applications is incorporated herein by reference.

### TECHNICAL FIELD

The present disclosure relates to the field of delivery technologies, and in particular to a delivery apparatus, a delivery system, a delivery method, an electronic device, and a computer readable storage medium.

### BACKGROUND

Along with development of internet technologies, more and more merchants or service providers provide services to users through internet platforms, and many internet services need to be delivered by deliverymen. Therefore, delivery efficiency is very important for improvement of service quality of the internet platforms. At present, the internet platforms usually schedule deliverymen based on application program to complete delivery of packages by human labor. In order to save human labor costs and improve the delivery efficiency, in the related arts, a delivery robot is designed and placed at a delivery location such as an office building, such that the delivery robot takes charge of delivery from a lobby to various users in the building. The delivery robot may autonomously call an elevator to transport packages to a user through the elevator, and then return to the lobby to continue waiting, and the deliveryman only needs to place packages into a service cabin of the delivery robot. The above intelligent delivery solution can save the human labor of the deliveryman to some degree, thus improving delivery efficiency. But, the existing delivery robots have a limited capacity and usually can only accommodate several to-be-delivered packages and even can accommodate only one package in a case of a large-volume package to be delivered. In this case, in a delivery peak period, almost all delivery robots are in a delivering state and thus the deliveryman has to wait for long before placing the to-be-delivered packages. Further, when the delivery robot reaches a destination floor, if a user cannot look for the delivery robot for taking packages in time, the delivery robot has to wait for long, severely affecting the delivery efficiency.

In order to solve the above shortcomings, an intelligent transfer service cabin is further disposed in a lobby in the related arts. When a delivery robot is in a delivery state, a deliveryman does not need to wait for the robot but directly place a to-be-delivered package into the service cabin for temporary storage. After the delivery robot completes the current service and returns to the lobby, the delivery robot may dock with the service cabin loaded with one or more to-be-delivered packages and the service cabin transfers the package to the robot for delivery. Although this solution can solve the problem that the deliveryman waits for too long, the following problems may still exist: tedious storage and transfer process, complex and expensive transfer mechanism; large occupation area of the service cabin, and high requirements for the location. But, the problem that the robot waits for user is still pending.

### SUMMARY

The embodiments of the present disclosure provide a delivery apparatus, a delivery system, a delivery method, an electronic device, and a computer readable storage medium.

According to a first aspect of embodiments of the present disclosure, there is provided a delivery apparatus. Specifically, the delivery apparatus includes a movable chassis detachably and electrically connected with a cabin; where the movable chassis is configured to include: a first controller mounted inside the movable chassis, and a moving component mounted at a bottom of the movable chassis and connected with the first controller to drive the movable chassis and the cabin to move to a target position according to an instruction of the first controller; the cabin is configured to have one or more accommodation spaces for accommodating to-be-delivered objects.

In combination with the first aspect, in a first implementation of the first aspect of the present disclosure, the movable chassis further includes: a chassis body; a lifting component mounted inside the chassis body and capable of moving up and down along a longitudinal direction, where a lifting platform is disposed on a top of the lifting component; a first electric connection component mounted on the lifting platform to establish an electrical connection between the movable chassis and the cabin; where the moving component is mounted at a bottom of the chassis body; and the first controller is mounted inside the chassis body and connected with the first electric connection component, the moving component and the lifting component to control the first electric connection component, the moving component and the lifting component.

In combination with the first aspect and its above implementation, in a second implementation of the first aspect of embodiments of the present disclosure, the movable chassis further includes: a first positioning component mounted on the lifting platform and configured to fix a relative position between the movable chassis and the cabin; and a first locking component, mounted on the lifting platform and configured to lock up a connection between the movable chassis and the cabin.

In combination with the first aspect and its above implementations, in a third implementation of the first aspect of embodiments of the present disclosure, the cabin includes a cabin body, provided with one or more accommodation spaces for accommodating to-be-delivered objects; a support component, mounted at a bottom of the cabin body to support the cabin and configured to form an accommodation space to accommodate the movable chassis; and a second electric connection component, mounted at the bottom of the cabin body to cooperate with the first electric connection component to establish the electrical connection between the cabin and the movable chassis.

In combination with the first aspect and its above implementations, in a fourth implementation of the first aspect of embodiments of the present disclosure, the cabin further includes: a second positioning component, mounted at the bottom of the cabin body and configured to cooperate with the first positioning component to fix the relative position between the cabin and the movable chassis; a second locking component, mounted at the bottom of the cabin body and configured to cooperate with the first locking component to lock up the connection between the cabin and the movable chassis; a second controller, mounted inside the cabin body and connected with the second electric connection component, the second positioning component and the second locking component to detect a cabin state and send the detected cabin state to a server.

According to a second aspect of embodiments of the present disclosure, there is provided a delivery system. Specifically, the delivery system includes: one or more movable chassis, one or more cabins and a processor, where the cabin is placed at a taking position of to-be-delivered objects to accommodate the to-be-delivered objects; the movable chassis is configured to, according to an instruction of the processor, accept a corresponding cabin to drive the cabin to move to a target position, so as to complete delivery of the to-be-delivered objects.

In combination with the second aspect, in a first implementation of the second aspect of the present disclosure, the movable chassis is detachably and electrically connected with the cabin.

In combination with the second aspect and its above implementation, in a second implementation of the second aspect of embodiments of the present disclosure, the movable chassis includes: a first controller mounted inside the movable chassis, and a moving component, mounted at a bottom of the movable chassis and connected with the first controller to drive the movable chassis and the cabin to move to a target position according to an instruction of the first controller; the cabin has one or more accommodation spaces for accommodating the to-be-delivered objects.

In combination with the second aspect and its above implementations, in a third implementation of the second aspect of embodiments of the present disclosure, the movable chassis further includes a chassis body; a lifting component, mounted inside the chassis body and capable of moving up and down along a longitudinal direction, where a lifting platform is disposed on a top of the lifting component; a first electric connection component, mounted on the lifting platform to establish an electrical connection between the movable chassis and the cabin; where the moving component is mounted at a bottom of the chassis body; and the first controller is mounted inside the chassis body and connected with the first electric connection component, the moving component and the lifting component to control the first electric connection component, the moving component and the lifting component.

In combination with the second aspect and its above implementations, in a fourth implementation of the second aspect of embodiments of the present disclosure, the movable chassis further includes: a first positioning component, mounted on the lifting platform and configured to fix a relative position between the movable chassis and the cabin; and a first locking component, mounted on the lifting platform and configured to lock up a connection between the movable chassis and the cabin.

In combination with the second aspect and its above implementations, in a fifth implementation of the second aspect of embodiments of the present disclosure, the cabin includes a cabin body, provided with one or more accommodation spaces for accommodating to-be-delivered objects; a support component, mounted at a bottom of the cabin body to support the cabin and configured to form an accommodation space to accommodate the movable chassis; and a second electric connection component, mounted at the bottom of the cabin body to cooperate with the first electric connection component to establish an electrical connection between the cabin and the movable chassis.

In combination with the second aspect and its above implementations, in a sixth implementation of the second aspect of embodiments of the present disclosure, the cabin further includes: a second positioning component, mounted at the bottom of the cabin body and configured to cooperate with the first positioning component to fix the relative position between the cabin and the movable chassis; a second locking component, mounted at the bottom of the cabin body and configured to cooperate with the first locking component to lock up the connection between the cabin and the movable chassis; and a second controller, mounted inside the cabin body and connected with the second electric connection component, the second positioning component and the second locking component to detect a cabin state and send the detected cabin state to a server.

According to a third aspect of embodiments of the present disclosure, there is provided a method of performing delivery using the above delivery system. Specifically, the method includes: in response to detecting a target cabin satisfies a preset delivery condition, determining a movable chassis capable of performing a delivery task, where the target cabin is loaded with one or more to-be-delivered objects; sending an accept command to the movable chassis to enable the movable chassis to accept the target cabin, where the accept command carries unique identification information of the target cabin and delivery task information; in response to receiving a successful accept message from the movable chassis, sending a delivery command to the movable chassis to enable the movable chassis to drive the target cabin to move to a target position based on the delivery task information.

In combination with the third aspect, in a first implementation of the third aspect of the present disclosure, the method further includes: in response to detecting a time length in which the movable chassis waits at the target position exceeds a first preset time length threshold, sending a release and return command to the movable chassis to enable the movable chassis to release a connection with the target cabin to leave the target cabin at the target position and return to a taking position of the to-be-delivered objects.

In combination with the third aspect and its above implementations, in a second implementation of the third aspect of embodiments of the present disclosure, the method further includes: in response to detecting that the to-be-delivered objects in the target cabin left at the target position are all taken out, determining a movable chassis capable of performing an accept task and sending a return and accept command to the movable chassis to enable the movable chassis to return to the target position to accept the target cabin and transport and place the target cabin at the taking position of the to-be-delivered objects.

According to a fourth aspect of embodiments of the present disclosure, there is provided a method of performing delivery using the above delivery system. Specifically, the method includes: in response to receiving an accept command from a server, accepting a target cabin at a taking position of to-be-delivered objects and sending a successful accept message to the server, where the accept command carries unique identification information of the target cabin and delivery task information, and the target cabin is loaded with one or more to-be-delivered objects; in response to receiving a delivery command from the server, driving the target cabin to move to a target position based on the delivery task information; in response to detecting that the to-be-delivered objects are all already taken out, driving the target cabin to return to the taking position of the to-be-delivered objects.

In combination with the fourth aspect, in a first implementation of the fourth aspect of the present disclosure, after, in response to receiving the delivery command from the server, driving the target cabin to move to the target position based on the delivery task information, the method further includes: in response to receiving a release and return command from the server, releasing a connection with the target cabin to leave the target cabin at the target position and returning to the taking position of the to-be-delivered objects.

In combination with the fourth aspect and its first implementation, in a second implementation of the fourth aspect of embodiments of the present disclosure, in response to detecting that the to-be-delivered objects are all already taken out, driving the target cabin to return to the taking position of the to-be-delivered objects is implemented by: in response to receiving a return and accept command from the server, moving to the target position to accept the target cabin left at the target position and transporting and placing the target cabin at the taking position of the to-be-delivered objects.

According to a fifth aspect of embodiments of the present disclosure, there is provided a delivery apparatus. Specifically, the delivery apparatus includes: a determining module, configured to, in response to detecting a target cabin satisfies a preset delivery condition, determine a movable chassis capable of performing a delivery task, where the target cabin is loaded with one or more to-be-delivered objects; a first sending module, configured to send an accept command to the movable chassis to enable the movable chassis to accept the target cabin, where the accept command carries unique identification information of the target cabin and delivery task information; a second sending module, configured to, in response to receiving a successful accept message from the movable chassis, send a delivery command to the movable chassis to enable the movable chassis to drive the target cabin to move to a target position based on the delivery task information.

In combination with the fifth aspect, in a first implementation of the fifth aspect of the present disclosure, the apparatus further includes: a third sending module, configured to, in response to detecting a time length in which the movable chassis waits at the target position exceeds a first preset time length threshold, send an accept release and return command to the movable chassis to enable the movable chassis to release a connection with the target cabin to leave the target cabin at the target position and return to a taking position of the to-be-delivered objects.

In combination with the fifth aspect and its above implementations, in a second implementation of the fifth aspect of embodiments of the present disclosure, the apparatus further includes: a fourth sending module, configured to, in response to detecting that the to-be-delivered objects in the target cabin left at the target position are all taken out, determine a movable chassis capable of performing an accept task and send a return and accept command to the movable chassis to enable the movable chassis to return to the target position to accept the target cabin and transport and place the target cabin at the taking position of the to-be-delivered objects.

According to a sixth aspect of embodiments of the present disclosure, there is provided a delivery apparatus. Specifically, the delivery apparatus includes: an accepting module, configured to, in response to receiving an accept command from a server, accept a target cabin at a taking position of to-be-delivered objects and send a successful accept message to the server, where the accept command carries unique identification information of the target cabin and delivery task information, and the target cabin is loaded with one or more to-be-delivered objects; a moving module, configured to, in response to receiving a delivery command from the server, drive the target cabin to move to a target position based on the delivery task information; a returning module, configured to, in response to detecting that the to-be-delivered objects are all already taken out, drive the target cabin to return to the taking position of the to-be-delivered objects.

In combination with the sixth aspect, in a first implementation of the sixth aspect of the present disclosure, the apparatus, in addition to the moving module, further includes: a releasing module, configured to, in response to receiving an accept release and return command from the server, release a connection with the target cabin to leave the target cabin at the target position and return to the taking position of the to-be-delivered objects.

In combination with the sixth aspect and its above implementations, in a second implementation of the sixth aspect of embodiments of the present disclosure, the returning module is configured to: in response to receiving a return and accept command from the server, move to the target position to accept the target cabin left at the target position and transport and place the target cabin at the taking position of the to-be-delivered objects.

According to a seventh aspect of embodiments of the present disclosure, there is provided an electronic device, including a memory and a processor, where the memory is configured to store one or more computer instructions, and the one or more computer instructions are executed by the processor to implement the steps of the above delivery method.

According to an eighth aspect of embodiments of the present disclosure, there is provided a computer readable storage medium, storing computer instructions used by a delivery apparatus, and containing computer instructions used by a delivery apparatus to perform the above delivery method.

The technical solutions provided by the embodiments of the present disclosure have the following beneficial effects.

In technical solutions, the movable chassis and the cabin which are detachably and electrically connected are disposed, and the movable chassis can drive the cabin to move to the target position, leave the cabin and re-accept the cabin based on different control instructions. In the above technical solutions, a delivery apparatus can be obtained by using the movable chassis and the cabin which can be combined freely to handle various delivery situations so as to complete delivery tasks, thus greatly improving the delivery efficiency, and lowering the delivery costs. In this way, the flexibility of delivery task scheduling can be improved, the occupation area for performing delivery tasks is reduced, and the cases in which the deliveryman waits for the delivery robot for too long and the robot waits for a user for too long can be avoided.

It should be understood that the above general descriptions and subsequent detailed descriptions are merely illustrative and explanatory rather than limiting of the present disclosure.

### BRIEF DESCRIPTION OF THE DRAWINGS

In combination with accompanying drawings, with detailed descriptions of the following non-limiting embodiments, other features, objects and advantages of the present disclosure will become more apparent.

FIGS. 1 and 2 are front view and side view respectively illustrating a delivery apparatus 100 according to an embodiment of the present disclosure.

FIGS. 3 and 4 are front view and side view respectively illustrating a movable chassis 110 according to an embodiment of the present disclosure.

FIG. 5 is a schematic diagram illustrating a state of a lifting component 112 at a lifted position in a movable chassis 110 according to an embodiment of the present disclosure.

FIGS. 6, 7 and 8 are front view, side view and top view respectively illustrating a cabin 120 according to an embodiment of the present disclosure.

FIG. 9 is a schematic structural diagram illustrating a delivery system 200 according to an embodiment of the present disclosure.

FIGS. 10 to 14 are flowcharts illustrating a method of performing delivery using the above delivery system according to embodiments of the present disclosure.

FIGS. 15 to 19 are structural block diagrams illustrating a delivery apparatus according to embodiments of the present disclosure.

FIG. 20 is a structural block diagram illustrating an electronic device according to an embodiment of the present disclosure.

FIG. 21 is a schematic structural diagram illustrating a computer system applicable to implementing a delivery method according to an embodiment of the present disclosure.

### DETAILED DESCRIPTION OF THE EMBODIMENTS

Exemplary embodiments of the present disclosure will be elaborated with reference to accompanying drawings to enable those skilled in the art to easily implement them. Further, the parts irrelevant to descriptions of the exemplary embodiments are omitted for clarity in the accompanying drawings.

In the present disclosure, it should be understood that the terms such as “include” and “have” are meant to indicate presence of features, digits, steps, behaviors, components and parts or a combination thereof disclosed in the specification and do not preclude possibility of presence or addition of one or more other features, digits, steps, behaviors, components and parts or a combination thereof.

Furthermore, it is noted that in a case of no conflicts, the embodiments and features of the embodiments in the present disclosure can be mutually combined. The present disclosure will be described in detail below in combination with accompanying drawings and specific embodiments.

In technical solutions provided by the embodiments of the present disclosure, a movable chassis and a cabin which are detachably and electrically connected are disposed, and the movable chassis can drive the cabin to move to a target position, leave the cabin and re-accept the cabin based on different control instructions. In the above technical solutions, a delivery apparatus can be obtained by using the movable chassis and the cabin which can be combined freely to handle various delivery situations so as to complete delivery tasks, thus greatly improving the delivery efficiency, and lowering the delivery costs. In this way, the flexibility of delivery task scheduling can be improved, the occupation area for performing delivery tasks is reduced, and the cases in which the deliveryman waits for the delivery robot for too long and the robot waits for a user for too long can be avoided.

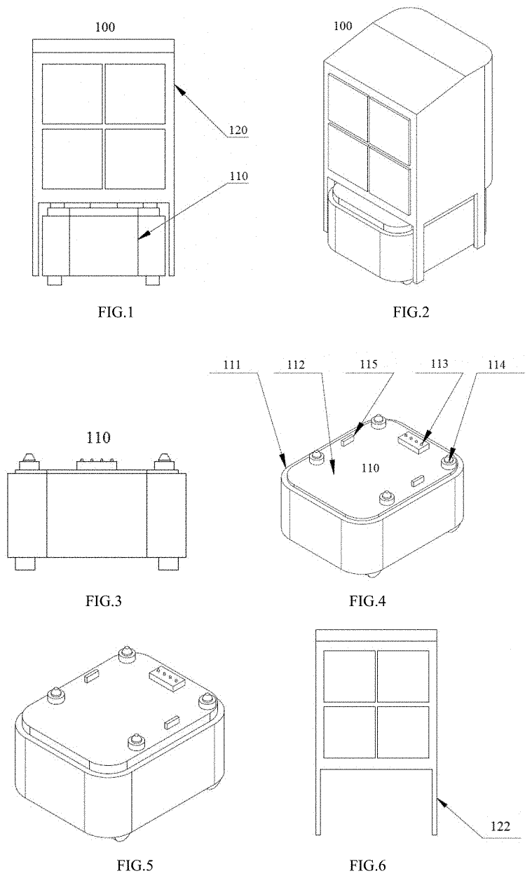

FIG. 1 is a front view illustrating a delivery apparatus 100 according to an embodiment of the present disclosure. FIG. 2 is a side view illustrating a delivery apparatus 100 according to an embodiment of the present disclosure. As shown in FIGS. 1 and 2, the delivery apparatus 100 includes a movable chassis 110 and a cabin 120.

The movable chassis 110 is detachably and electrically connected with the cabin 120.

The movable chassis 110 includes a moving component and a first controller, and the moving component is mounted at a bottom of the movable chassis 110 to drive the movable chassis 110 and the cabin 120 to move to a target position according to an instruction of the first controller.

The cabin 120 has one or more accommodation spaces for accommodating to-be-delivered objects.

As mentioned above, along with development of internet technologies, more and more merchants or service providers provide services to users through internet platforms, and many internet services need to be delivered by deliverymen. Therefore, delivery efficiency is very important for improvement of service quality of the internet platforms. In the related arts, there exist the following several solutions: a deliveryman is scheduled based on application program to complete delivery of packages by human labor; a delivery robot is employed to deliver packages at a delivery location; an intelligent transfer service cabin is disposed to temporarily store to-be-delivered packages, the delivery robot docks with the service cabin, and the service cabin transfers the packages to the robot for delivery. The above technical solutions each have unsolvable problems, for example, high labor cost, low delivery efficiency, too long waiting time of deliveryman, too long waiting time of robot, tedious storage and transfer process, complex and expensive transfer mechanism, large occupation area of service cabin and high requirements for location and the like.

In view of the above problems, in this embodiment, a delivery apparatus is provided. The apparatus is provided with a movable chassis and a cabin which are detachably and electrically connected. The movable chassis can drive the cabin to move to a target position, leave the cabin and re-accept the cabin based on different control instructions. In the above technical solution, a delivery apparatus can be obtained by using the movable chassis and the cabin which can be combined freely to handle various delivery situations so as to complete delivery tasks, thus greatly improving the delivery efficiency, and lowering the delivery costs. In this way, the flexibility of delivery task scheduling can be improved, the occupation area for performing delivery tasks is reduced, and the cases in which the deliveryman waits for the delivery robot for too long and the robot waits for a user for too long can be avoided.

As shown in FIGS. 1 and 2, the movable chassis 110 is detachably and electrically connected with the cabin 120. Further, the movable chassis 110 is connected with the cabin 120 along a longitudinal direction. Based on a received control instruction, the movable chassis 110 may connect with the cabin 120, and drive the cabin 120 to move to a target position, and then disconnect with the cabin 120 to leave the cabin 120 at the target position, or move to the target position to re-connect with the cabin 120, and drive the cabin 120 to move to another target position.

The movable chassis 100 includes a moving component (not shown) and a first controller (not shown), the first controller is mounted inside the movable chassis 110, the moving component is mounted at a bottom of the movable chassis 110 and connected with the first controller to drive the movable chassis 110 and the cabin 120 to move to a target position according to an instruction of the first controller.

In some examples, the moving component may be a wheel component such as a moving wheel or a caterpillar component such as a moving caterpillar. Those skilled in the art may select an appropriate moving component according to the requirements of actual application, as long as the moving component can drive the movable chassis 110 and the cabin 120 to move in multiple directions. Thus, no limitation is made in the present disclosure.

The cabin 120 has one or more accommodation spaces for accommodating to-be-delivered objects. In some examples, the accommodation spaces may be same or different in size to accommodate the to-be-delivered objects of different sizes, so as to avoid the case in which, due to difference between the sizes of the to-be-delivered object and the accommodation space, a to-be-delivered object of large volume cannot be accommodated or a to-be-delivered object of small volume occupies a large space.

In some examples, the accommodation spaces are formed by use of one or more partitioning components. Further, the partitioning component is a detachable component which can be mounted or dismounted as required such that the accommodation space can be adjusted in size.

FIG. 3 is a front view illustrating a movable chassis 110 according to an embodiment of the present disclosure. FIG. 4 is a side view illustrating a movable chassis 110 according to an embodiment of the present disclosure. FIG. 5 is a schematic diagram illustrating a state of a lifting component 112 at a lifted position in a movable chassis 110 according to an embodiment of the present disclosure. As shown in FIGS. 3 to 5, the movable chassis 110 further includes a chassis body 111, a lifting component 112 and a first electric connection component 113.

The moving component is mounted at a bottom of the chassis body 111.

The lifting component 112 is mounted inside the chassis body 111 and capable of moving up and down along a longitudinal direction, where a lifting platform is disposed on a top of the lifting component 112.

The electric connection component 113 is mounted on the lifting platform to establish electrical connection between the movable chassis 110 and the cabin 120.

The first controller is mounted inside the chassis body 111 and connected with the first electric connection component 113, the moving component and the lifting component 112 to control the first electric connection component, the moving component and the lifting component.

In this implementation, the lifting component 112 can move up and down along a longitudinal direction. When the lifting component 112 is at an initial position, the lifting platform on the top of the lifting component 112 is flush with a top of the chassis body 111. When the lifting component 112 is at a lifted position, as shown in FIG. 5, the lifting platform on the top of the lifting component 112 is distanced from the top of the chassis body 111 in the longitudinal direction to enable the cabin 120 accepted by the lifting platform to be moved away from the ground longitudinally and further moved under the drive of the moving component.

In this implementation, the first electric connection component 113 is mounted on the lifting platform. For example, the first electric connection component 113 may be mounted in the middle of the lifting platform or at a position close to an outer side on the lifting platform. The first electric connection component 113 may cooperate with an electric connection component of the cabin 120 to establish electrical connection between the movable chassis 110 and the cabin 120, so as to perform power transmission and electrical signal communication.

In this implementation, the first controller is mounted inside the chassis body 111 and connected with the first electric connection component 113, the moving component and the lifting component 112 to control the first electric connection component 113, the moving component and the lifting component 112. For example, the first controller may receive an electrical signal from the cabin 120 through the electric connection component, control movement of the moving component and lifting of the lifting component and the like.

Further, in some examples, the movable chassis 110 further includes: a first positioning component 114 and a first locking component 115.

The first positioning component 114 and the first locking component 115 are mounted on the lifting platform, the first positioning component 114 is configured to fix a relative position between the movable chassis 110 and the cabin 120, and the first locking component 115 is configured to lock up connection between the movable chassis 110 and the cabin 120.

In this implementation, the first positioning component 114 and the first locking component 115 may be mounted in the middle of the lifting platform or at positions close to an outer side on the lifting platform. The first positioning component 114 and the first locking component 115 may cooperate with a positioning component and a locking component of the cabin 120 to fix a relative position between the movable chassis 110 and the cabin 120, and lock up connection between the movable chassis 110 and the cabin 120, thus ensuring the cabin 120 will not separate from or slip off the movable chassis 110 during a movement process.

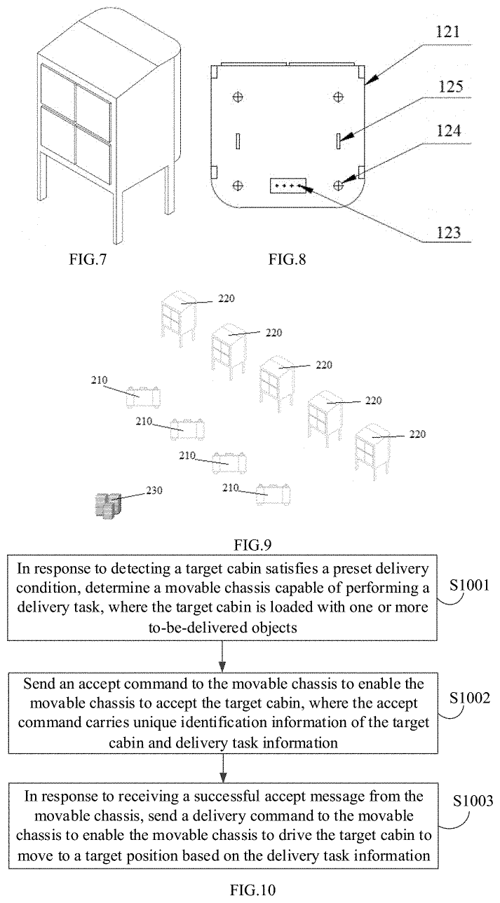

FIG. 6 is a front view illustrating a cabin 120 according to an embodiment of the present disclosure. FIG. 7 is a side view illustrating a cabin 120 according to an embodiment of the present disclosure. FIG. 8 is a top view illustrating a cabin 120 according to an embodiment of the present disclosure. As shown in FIGS. 6 to 8, the cabin 120 includes a cabin body 121, a support component 122 and a second electric connection component 123.

The cabin body 121 is provided with one or more accommodation spaces for accommodating to-be-delivered objects.

The support component 122 is mounted at a bottom of the cabin body 121 to support the cabin 120.

The support component 122 forms an accommodation space to accommodate the movable chassis 110.

The second electric connection component 123 is mounted at a bottom of the cabin body 121 to cooperate with the first electric connection component 113 to establish electrical connection between the cabin 120 and the movable chassis 110.

In this implementation, the cabin body 121 has one or more accommodation spaces for accommodating to-be-delivered objects. As mentioned above, the accommodation spaces may be same or different in size to accommodate the to-be-delivered objects of different sizes, so as to avoid the case in which, due to difference between the sizes of the to-be-delivered object and the accommodation space, a to-be-delivered object of large volume cannot be accommodated or a to-be-delivered object of small volume occupies a large space.

In this implementation, the support component 122 is mounted at the bottom of the cabin body 121 to support the cabin 120 and the support component 122 forms an accommodation space (also referred to as “support space” hereinafter) to accommodate the movable chassis 110. The support component 122 may include, for example, a plurality of support columns which are respectively disposed at different positions of the bottom of the cabin body 121 to support the cabin and further form a hollow space. When required to carry the cabin 120, the movable chassis 110 may move to the hollow space. A distance between a top of the support component 122 and the ground is smaller than a distance between the lifting platform at the top of the lifting component 112 and the ground when the lifting component 112 of the movable chassis 110 is at a lifted position. In this case, when the movable chassis 110 needs to carry the cabin 120, the lifting component 112 is enabled to be at an initial position and moved to the accommodation space formed by the support component 122, and then lifted to enable the cabin 120 to move away from the ground under the lift of the lifting component 112 and further move the cabin 120 under the drive of the movable chassis 110.

In this implementation, the second electric connection component 123 is mounted at the bottom of the cabin body 121. For example, the second electric connection component 123 is mounted in the middle of the bottom of the cabin body 121, or at a position close to an outer side on the bottom of the cabin body 121. The second electric connection component 123 cooperates with the electric connection component of the movable chassis 110 to establish electrical connection between the cabin 120 and the movable chassis 110, so as to perform power transmission and electrical signal communication.

Furthermore, in some examples, the cabin 120 further includes a second positioning component 124, a second locking component 125 and a second controller.

The second positioning component 124 and the second locking component 125 are mounted at the bottom of the cabin body 121. The second positioning component 124 is configured to cooperate with the first positioning component 114 to fix a relative position between the cabin 120 and the movable chassis 110. The second locking component 125 is configured to cooperate with the first locking component 115 to lock up connection between the cabin 120 and the movable chassis 110.

The second controller is mounted inside the cabin body 121 and connected with the second electric connection component 123, the second positioning component 124 and the second locking component 125, and configured to detect a cabin state and send the detected cabin state to a server.

In this implementation, the second positioning component 124 and the second locking component 125 may be mounted in the middle of the bottom of the cabin body 121, or at a position close to an outer side on the bottom of the cabin body 121. The second positioning component 124 and the second locking component 125 may cooperate with the positioning component and the locking component of the movable chassis 110 to fix a relative position between the movable chassis 110 and the cabin 120, and lock up connection between the movable chassis 110 and the cabin 120, thus ensuring the cabin 120 will not separate from or slip off the movable chassis 110 during a movement process.

In this implementation, the second controller is mounted inside the cabin body 121 and connected with the second electric connection component 123, the second positioning component 124 and the second locking component 125 and configured to detect a cabin state and send the detected cabin state to a server. The cabin state may include, for example, an electrically-connected state of the cabin, a positioned state of the cabin and a locked state of the cabin and the like.

Based on the above technical solution, the movable chassis 110 and the cabin 120 may be assembled to form a delivery apparatus. The controller may, based on an instruction from the server, control the moving component of the movable chassis 110 to move to the support space of the cabin 120, control the lifting component 112 to lift to enable the cabin 120 to move away from the ground, control the moving component to move to a target position for delivery, control the lifting component 112 to fall to enable the cabin 120 to fall onto the ground, and control the moving component to move away from the support space of the cabin 120. In this way, the movable chassis 110 can, based on different control instructions, drive the cabin to move to a target position for delivery, leave the cabin at the target position when required to wait for too long for delivery, and return to the target position to accept and bring back the cabin when the to-be-delivered objects in the cabin are all already taken out. Therefore, this technical solution can handle various delivery situations, thus improving the delivery efficiency and reducing the delivery costs. In this way, the flexibility of delivery task scheduling can be improved, the occupation area for performing delivery tasks is reduced, and the cases in which the deliveryman waits for the delivery robot for too long and the robot waits for a user for too long can be avoided.

FIG. 9 is a schematic structural diagram illustrating a delivery system according to an embodiment of the present disclosure. As shown in FIG. 9, the delivery system includes one or more movable chassis 210, one or more cabins 220 and a processor 230.

The cabin 220 is placed at a taking position of to-be-delivered objects to accommodate the to-be-delivered objects.

The movable chassis 210 is configured to, according to an instruction of the processor 230, accept a corresponding cabin 220 to drive the cabin 220 to move to a target position, so as to complete delivery of the to-be-delivered objects.

As mentioned above, along with development of internet technologies, more and more merchants or service providers provide services to users through internet platforms, and many internet services need to be delivered by deliverymen. Therefore, delivery efficiency is very important for improvement of service quality of the internet platforms. In the related arts, there exist the following several solutions: a deliveryman is scheduled based on application program to complete delivery of packages by human labor; a delivery robot is employed to deliver packages at a delivery location; an intelligent transfer service cabin is disposed to temporarily store to-be-delivered packages, the delivery robot docks with the service cabin, and the service cabin transfers the packages to the robot for delivery. The above technical solutions each have unsolvable problems, for example, high labor cost, low delivery efficiency, too long waiting time of deliveryman, too long waiting time of robot, tedious storage and transfer process, complex and expensive transfer mechanism, large occupation area of service cabin and high requirements for location and the like.

In view of the above problems, in the embodiment there is provided a delivery system which includes a movable chassis and cabin detachably and electrically connected, where the movable chassis can drive the cabin to move to the target position, leave the cabin and re-accept the cabin based on different control instructions. In the above technical solution, a delivery apparatus may be obtained by using the movable chassis and the cabin which can be combined freely to handle various delivery situations so as to complete delivery tasks, thus greatly improving the delivery efficiency, and lowering the delivery costs. In this way, the flexibility of delivery task scheduling can be improved, the occupation area for performing delivery tasks is reduced, and the cases in which the deliveryman waits for the delivery robot for too long and the robot waits for a user for too long can be avoided.

In this embodiment, one or more cabins 220 are placed at the taking position of the to-be-delivered objects to accommodate the to-be-delivered objects. The movable chassis 210 may accept the corresponding cabin based on an instruction of the processor 230 to drive the cabin to move to the target position, so as to complete the delivery of the to-be-delivered objects.

The number of the movable chassis 210 and the number of the cabins 220 may be same or different. In an actual application, the number of the movable chassis 210 and the number of the cabins 220 may be determined by those skilled in the art according to actual requirements, for example, the number of to-be-delivered objects and a transport capability of the movable chassis. During execution of a delivery task, the number of the movable chassis 210 and the number of the cabins 220 may also be adjusted based on the requirements of actual application.

In some examples, the movable chassis 210 is detachably and electrically connected with the cabin 220.

In some examples, the movable chassis 210 includes a moving component and a first controller, the first controller is mounted inside the movable chassis 210, the moving component is mounted at a bottom of the movable chassis 210 and connected with the first controller to drive the movable chassis 210 and the cabin 220 to move to a target position according to an instruction of the first controller.

The cabin 220 has one or more accommodation spaces for accommodating to-be-delivered objects.

In some examples, the movable chassis 210 further includes a chassis body, a lifting component and a first electric connection component.

The moving component is mounted at a bottom of the chassis body.

The lifting component is mounted inside the chassis body and capable of moving up and down along a longitudinal direction, where a lifting platform is disposed on a top of the lifting component.

The first electric connection component is mounted on the lifting platform to establish electrical connection between the movable chassis and the cabin.

The first controller is mounted inside the chassis body and connected with the first electric connection component, the moving component and the lifting component to control the first electric connection component, the moving component and the lifting component.

In some examples, the movable chassis 210 further includes: a first positioning component and a first locking component.

The first positioning component and the first locking component are mounted on the lifting platform. The first positioning component is configured to fix a relative position between the movable chassis and the cabin, and the first locking component is configured to lock up connection between the movable chassis and the cabin.

In some examples, the cabin 220 includes a cabin body, a support component and a second electric connection component.

The cabin body is provided with one or more accommodation spaces for accommodating to-be-delivered objects.

The support component is mounted at a bottom of the cabin body to support the cabin.

The support component forms an accommodation space to accommodate the movable chassis.

The second electric connection component is mounted at a bottom of the cabin body to cooperate with the first electric connection component to establish electrical connection between the cabin and the movable chassis.

In some examples, the cabin 220 further includes: a second positioning component, a second locking component and a second controller.

The second positioning component and the second locking component are mounted at a bottom of the cabin body. The second positioning component is configured to cooperate with the first positioning component to fix a relative position between the cabin and the movable chassis. The second locking component is configured to cooperate with the first locking component to lock up connection between the cabin and the movable chassis.

The second controller is mounted inside the cabin body and connected with the second electric connection component, the second positioning component and the second locking component and configured to detect a cabin state and send the detected cabin state to a server.

The technical features of the movable chassis and the cabin are already detailed above and will no longer be repeated herein.

It is noted that, overall sizes of one or more cabins 220 may be same or different, but it should be ensured that: the second electric connection components, the second positioning components and the second locking components of the cabins 220 have the same structural position to be able to normally dock with the movable chassis 210; the support component of the cabin 220 can form an accommodation space sufficient to accommodate the movable chassis 210; a distance between a top of the support component and the ground is smaller than a distance between the lifting platform on the top of the lifting component and the ground when the lifting component of the movable chassis 210 is at a lifted position, such that the movable chassis 210 can move to the accommodation space formed by the support components; and the cabin 220 can be moved away from the ground under the lift of the lifting component and moved under the drive of the movable chassis 210.

Based on the above technical solution, one or more cabins 220 may be placed at the taking position of the to-be-delivered objects in advance to wait for loading of the to-be-delivered objects. When the accommodation space of the cabin 220 is fully loaded with to-be-delivered objects, or loaded with at least one to-be-delivered object for a loading time length exceeding a first preset time length threshold, it is thought that the cabin 220 satisfies a delivery condition and may be delivered. At this time, the processor may send an instruction to the movable chassis 210 to enable it to accept the cabin 220, that is, enable the movable chassis 210 to move to the support space of the cabin 220 and lift the lifting component to move the cabin 220 away from the ground to form a delivery apparatus and then move it to a target position for delivery. After all the to-be-delivered objects in the cabin 220 are taken out, the movable chassis 210 may carry the cabin 220 back to the taking position of the to-be-delivered objects based on an instruction of the processor. However, if the movable chassis 210 waits for a time length exceeding a second preset time length threshold at the target position, in order to improve the delivery efficiency, the movable chassis 210 may be disconnected with the cabin 220 to leave the cabin 220 at the target position, and then the movable chassis 210 alone returns to the taking position of the to-be-delivered objects to accept other cabins 220 satisfying the delivery condition. After the to-be-delivered objects in the cabin 220 left at the target position are all taken out, one idle movable chassis 210 may be selected and moved to the target position to bring back the left cabin 220 to the taking position of the to-be-delivered objects. It can be seen that this technical solution can handle various delivery situations, thus greatly improving the delivery efficiency, and lowering the delivery costs. In this way, the flexibility of delivery task scheduling can be improved, the occupation area for performing delivery tasks is reduced, and the cases in which the deliveryman waits for the delivery robot for too long and the robot waits for a user for too long can be avoided.

FIG. 10 is a flowchart illustrating a method of performing delivery using the above delivery system according to an embodiment of the present disclosure. The method may be applied to a server. As shown in FIG. 10, the method includes the following steps S1001 to S1003.

At step S1001, in response to detecting a target cabin satisfies a preset delivery condition, a movable chassis capable of performing a delivery task is determined, where the target cabin is loaded with one or more to-be-delivered objects.

At step S1002, an accept command is sent to the movable chassis to enable the movable chassis to accept the target cabin, where the accept command carries unique identification information of the target cabin and delivery task information.

At step S1003, in response to receiving a successful accept message from the movable chassis, a delivery command is sent to the movable chassis to enable the movable chassis to drive the target cabin to move to a target position based on the delivery task information.

As mentioned above, along with development of internet technologies, more and more merchants or service providers provide services to users through internet platforms, and many internet services need to be delivered by deliverymen. Therefore, delivery efficiency is very important for improvement of service quality of the internet platforms. In the related arts, there exist the following several solutions: a deliveryman is scheduled based on application program to complete delivery of packages by human labor; a delivery robot is employed to deliver packages at a delivery location; an intelligent transfer service cabin is disposed to temporarily store to-be-delivered packages, the delivery robot docks with the service cabin, and the service cabin transfers the packages to the robot for delivery. The above technical solutions each have unsolvable problems, for example, high labor cost, low delivery efficiency, too long waiting time of deliveryman, too long waiting time of robot, tedious storage and transfer process, complex and expensive transfer mechanism, large occupation area of service cabin and high requirements for location and the like.

In view of the above problems, in this embodiment, a delivery method is provided. In this method, a movable chassis and a cabin which are detachably and electrically connected are employed. The movable chassis is controlled to drive the cabin to move to a target position, leave the cabin and re-accept the cabin. In the above technical solution, a delivery apparatus can be obtained by using the movable chassis and the cabin which can be combined freely to handle various delivery situations so as to complete delivery tasks, thus greatly improving the delivery efficiency, and lowering the delivery costs. In this way, the flexibility of delivery task scheduling can be improved, the occupation area for performing delivery tasks is reduced, and the cases in which the deliveryman waits for the delivery robot for too long and the robot waits for a user for too long can be avoided.

In some examples, the preset delivery condition may include one or more of the following conditions: the accommodation space of the cabin is fully loaded with to-be-delivered objects, and the accommodation space of the cabin is loaded with at least one to-be-delivered object for a loading time length exceeding a first preset time length threshold. When a cabin satisfies the above preset delivery condition, it is thought that delivery can be performed. Then, one movable chassis capable of performing the delivery task may be determined to accept the cabin, where the movable chassis capable of performing the delivery task may be, for example, a movable chassis in an idle state and the like.

In some examples, the to-be-delivered object refers to an object to be delivered to a position or location, such as a product and a commodity.

In some examples, after the movable chassis capable of performing the delivery task is determined, an accept command may be sent to the movable chassis to enable it to move to the support space of the cabin and lift the lifting component to move the cabin away from the ground to form a delivery apparatus. The accept command carries unique identification information of the target cabin and delivery task information. The unique identification information of the target cabin is used to enable the movable chassis to confirm the cabin to accept, and the delivery task information at least includes one or more of the following information: target position, information of a to-be-delivered object, reception information and the like. According to the delivery task information, the movable chassis may obtain a target position and determine a travel path.

In some examples, after a successful accept message is received from the movable chassis, a delivery command may be sent to the movable chassis to enable the movable chassis to, based on the delivery task information, especially target position information in the delivery task information, drive the target cabin to move to the target position, thus completing delivery.

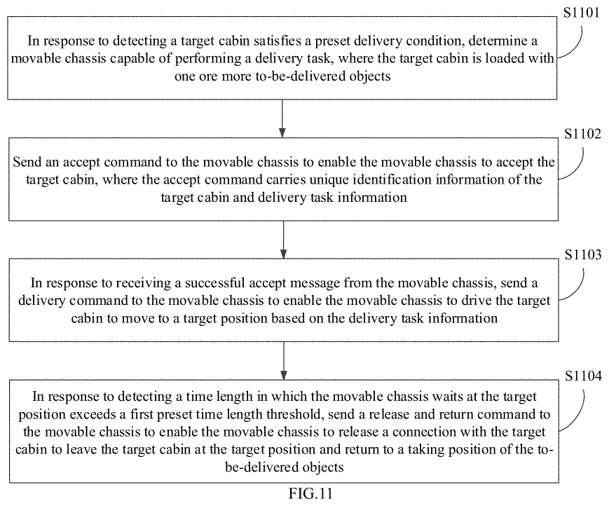

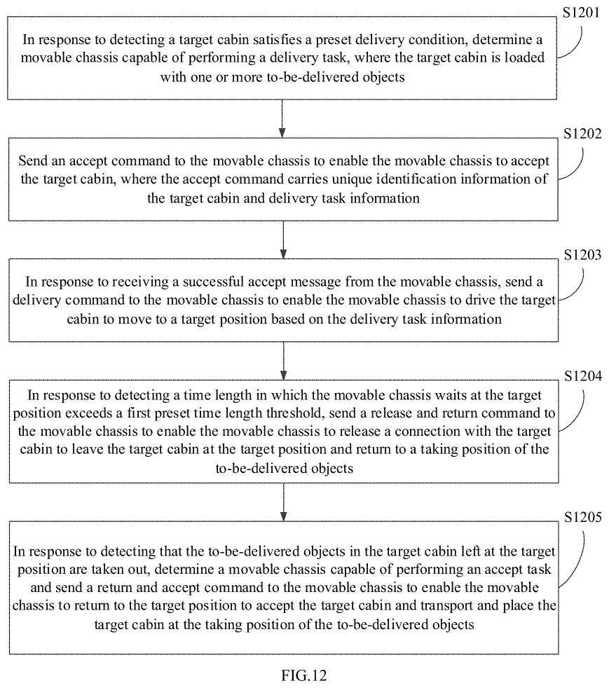

In some examples, the method further includes: in response to detecting a time length in which the movable chassis waits at the target position exceeds a first preset time length threshold, sending a release and return command to the movable chassis to enable the movable chassis to release a connection with the target cabin to leave the target cabin at the target position and return to the taking position of the to-be-delivered objects. As shown in FIG. 11, the delivery method may include the following steps S1101 to S1104.

At step S1101, in response to detecting a target cabin satisfies a preset delivery condition, a movable chassis capable of performing a delivery task is determined, where the target cabin is loaded with one or more to-be-delivered objects.

At step S1102, an accept command is sent to the movable chassis to enable the movable chassis to accept the target cabin, where the accept command carries unique identification information of the target cabin and delivery task information.

At step S1103, in response to receiving a successful accept message from the movable chassis, a delivery command is sent to the movable chassis to enable the movable chassis to drive the target cabin to move to a target position based on the delivery task information.

At step S1104, in response to detecting a time length in which the movable chassis waits at the target position exceeds a first preset time length threshold, a release and return command is sent to the movable chassis to enable the movable chassis to release a connection with the target cabin to leave the target cabin at the target position and return to a taking position of the to-be-delivered objects.

Considering that after the movable chassis reaches the target position, it is possible that a user cannot take out the to-be-delivered object in time because the user is at a meeting or telephone is unavailable or the like. In order to save the delivery time and improve the delivery efficiency, in this implementation, if it is detected that the time length in which the movable chassis waits at the target position exceeds the first preset time length threshold, it is thought that it is no need to wait for any more time. In this case, a release and return command is sent to the movable chassis to enable the movable chassis to release a connection with the target cabin to leave the target cabin at the target position to wait for the user to take the to-be-delivered object and enable the movable chassis to return to the taking position of the to-be-delivered objects to continue accepting other cabins to perform other delivery tasks.

In some examples, the method further includes: in response to detecting that the to-be-delivered objects in the target cabin left at the target position are all taken out, determining a movable chassis capable of performing an accept task and sending a return and accept command to the movable chassis to enable the movable chassis to return to the target position to accept the target cabin and transport and place the target cabin at the taking position of the to-be-delivered objects. As shown in FIG. 12, the delivery method includes the following steps S1201 to S1205.

At step S1201, in response to detecting a target cabin satisfies a preset delivery condition, a movable chassis capable of performing a delivery task is determined, where the target cabin is loaded with one or more to-be-delivered objects.

At step S1202, an accept command is sent to the movable chassis to enable the movable chassis to accept the target cabin, where the accept command carries unique identification information of the target cabin and delivery task information.

At step S1203, in response to receiving a successful accept message from the movable chassis, a delivery command is sent to the movable chassis to enable the movable chassis to drive the target cabin to move to a target position based on the delivery task information.

At step S1204, in response to detecting a time length in which the movable chassis waits at the target position exceeds a first preset time length threshold, a release and return command is sent to the movable chassis to enable the movable chassis to release a connection with the target cabin to leave the target cabin at the target position and return to a taking position of the to-be-delivered objects.

At step S1205, in response to detecting that the to-be-delivered objects in the target cabin left at the target position are all taken out, a movable chassis capable of performing an accept task is determined and a return and accept command is sent to the movable chassis to enable the movable chassis to return to the target position to accept the target cabin and transport and place the target cabin at the taking position of the to-be-delivered objects.

After the target cabin is left at the target position, in order to call back the cabin in an idle state to continue accommodating to-be-delivered objects in time, in this implementation, when it is detected that the to-be-delivered objects in the target cabin left at the target position are all taken out, a movable chassis capable of performing a cabin accept task at this time is determined. A return and accept command is sent to the movable chassis to enable the movable chassis to move to the target position to accept the target cabin and carry back and place the target cabin at the taking position of the to-be-delivered objects. The movable chassis capable of performing the cabin accept task may be the movable chassis which previously transports the target cabin to the target position, or another movable chassis in an idle state.

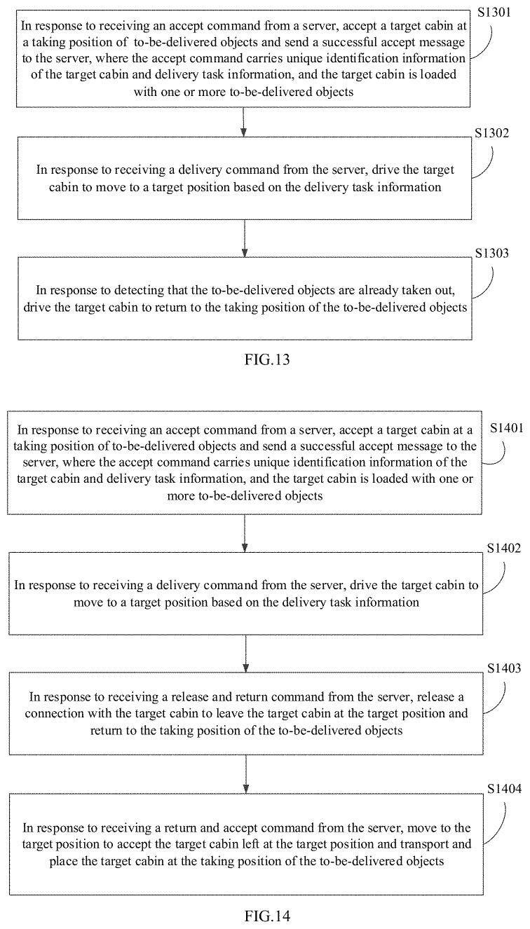

FIG. 13 is a flowchart illustrating a method of performing delivery using the above delivery system according to another embodiment of the present disclosure. The method may be applied to a movable chassis. As shown in FIG. 13, the delivery method may include the following steps S1301 to S1303.

At step S1301, in response to receiving an accept command from a server, a target cabin is accepted at a taking position of to-be-delivered objects and a successful accept message is sent to the server. The accept command carries unique identification information of the target cabin and delivery task information, and the target cabin is loaded with one or more to-be-delivered objects.

At step S1302, in response to receiving a delivery command from the server, the target cabin is driven to move to a target position based on the delivery task information.

At step S1303, in response to detecting that the to-be-delivered objects are all already taken out, the target cabin is driven to return to the taking position of the to-be-delivered objects.

As mentioned above, along with development of internet technologies, more and more merchants or service providers provide services to users through internet platforms, and many internet services need to be delivered by deliverymen. Therefore, delivery efficiency is very important for improvement of service quality of the internet platforms. In the related arts, there exist the following several solutions: a deliveryman is scheduled based on application program to complete delivery of packages by human labor; a delivery robot is employed to deliver packages at a delivery location; an intelligent transfer service cabin is disposed to temporarily store to-be-delivered packages, the delivery robot docks with the service cabin, and the service cabin transfers the packages to the robot for delivery. The above technical solutions each have unsolvable problems, for example, high labor cost, low delivery efficiency, too long waiting time of deliveryman, too long waiting time of robot, tedious storage and transfer process, complex and expensive transfer mechanism, large occupation area of service cabin and high requirements for location and the like.

In view of the above problems, in this embodiment, a delivery method is provided. The method uses detachable and electrical connection of the movable chassis with the cabin to, based on a received instruction, drive the cabin to move to a target position, leave the cabin and re-accept the cabin. In the above technical solution, a delivery apparatus can be obtained by using the movable chassis and the cabin which can be combined freely to handle various delivery situations so as to complete delivery tasks, thus greatly improving the delivery efficiency, and lowering the delivery costs. In this way, the flexibility of delivery task scheduling can be improved, the occupation area for performing delivery tasks is reduced, and the cases in which the deliveryman waits for the delivery robot for too long and the robot waits for a user for too long can be avoided.

In some examples, the to-be-delivered object refers to an object to be delivered to a position or location, such as a product and a commodity.

In some examples, after the movable chassis receives an accept command sent by the server based on a deliverable state of the cabin, the movable chassis may accept the target cabin at the taking position of the to-be-delivered objects, dock with the target cabin successfully and then send a successful accept message to the server. The accept command carries unique identification information of the target cabin and delivery task information, the target cabin is loaded with one or more to-be-delivered objects. The unique identification information of the target cabin is used to enable the movable chassis to confirm the cabin to accept, and the delivery task information at least includes one or more of the following information: target position, information of a to-be-delivered object, reception information and the like. According to the delivery task information, the movable chassis may obtain a target position and determine a travel path.

In some examples, after the movable chassis successfully accepts the target cabin and receives a delivery command from the server, the movable chassis may, based on the delivery task information, especially target position information in the delivery task information, drive the target cabin to move to the target position, thus completing delivery.

In some examples, after it is detected that all to-be-delivered objects are taken out, the target cabin in an idle state is driven to return to the taking position of the to-be-delivered objects to continue accommodating other to-be-delivered objects.

In some examples, the method may, after the step S1302, further include: in response to receiving a release and return command from the server, releasing a connection with the target cabin to leave the target cabin at the target position and returning to the taking position of the to-be-delivered objects. In this implementation, the step S1303, i.e. in response to detecting that the to-be-delivered objects are all already taken out, driving the target cabin to return to the taking position of the to-be-delivered objects is implemented by: in response to receiving a return and accept command from the server, moving to the target position to accept the target cabin left at the target position and transporting and placing the target cabin at the taking position of the to-be-delivered objects. As shown in FIG. 14, the delivery method includes the following steps S1401 to S1404.

At step S1401, in response to receiving an accept command from a server, a target cabin is accepted at a taking position of to-be-delivered objects and a successful accept message is sent to the server, where the accept command carries unique identification information of the target cabin and delivery task information, and the target cabin is loaded with one or more to-be-delivered objects.

At step S1402, in response to receiving a delivery command from the server, the target cabin is driven to move to a target position based on the delivery task information.

At step S1403, in response to receiving a release and return command from the server, a connection with the target cabin is released to leave the target cabin at the target position and return to the taking position of the to-be-delivered objects.

At step S1404, in response to receiving a return and accept command from the server, move is performed to the target position to accept the target cabin left at the target position and transport and place the target cabin at the taking position of the to-be-delivered objects.

Considering that after the movable chassis reaches the target position, it is possible that a user cannot take out the to-be-delivered object in time because the user is at a meeting or telephone is unavailable or the like. In order to save the delivery time and improve the delivery efficiency, in this implementation, if it is detected that the time length in which the movable chassis waits at the target position exceeds the first preset time length threshold, it is thought that it is no need to wait for any more time. In this case, the server may send a release and return command to the movable chassis. The movable chassis receives the release and return command and then releases a connection with the target cabin to leave the target cabin at the target position to wait for the user to take the to-be-delivered object and the movable chassis returns alone to the taking position of the to-be-delivered objects to continue accepting other cabins satisfying the delivery condition. Afterwards, after all to-be-delivered objects in the target cabin are taken out and the movable chassis receives a return and accept command from the server, the movable chassis may move to the target position to accept the target cabin left at the target position and transport and place the target cabin at the taking position of the to-be-delivered objects to enable it to continue accommodating other to-be-delivered objects.

In the above implementation, in order to further improve the delivery efficiency, the reception addresses corresponding to the to-be-delivered objects loaded into a same cabin are same or similar.

The following is an embodiment of an apparatus of the present disclosure which may be used to execute the method embodiments of the present disclosure.

FIG. 15 is a structural block diagram illustrating a delivery apparatus according to an embodiment of the present disclosure. The apparatus may be implemented as part or all of an electronic device by software, or hardware or a combination of both and may also be implemented as a server. As shown in FIG. 15, the delivery apparatus includes:

a determining module 1501, configured to, in response to detecting a target cabin satisfies a preset delivery condition, determine a movable chassis capable of performing a delivery task, where the target cabin is loaded with one or more to-be-delivered objects;

a first sending module 1502, configured to send an accept command to the movable chassis to enable the movable chassis to accept the target cabin, where the accept command carries unique identification information of the target cabin and delivery task information;

a second sending module 1503, configured to, in response to receiving a successful accept message from the movable chassis, send a delivery command to the movable chassis to enable the movable chassis to drive the target cabin to move to a target position based on the delivery task information.

As mentioned above, along with development of internet technologies, more and more merchants or service providers provide services to users through internet platforms, and many internet services need to be delivered by deliverymen. Therefore, delivery efficiency is very important for improvement of service quality of the internet platforms. In the related arts, there exist the following several solutions: a deliveryman is scheduled based on application program to complete delivery of packages by human labor; a delivery robot is employed to deliver packages at a delivery location; an intelligent transfer service cabin is disposed to temporarily store to-be-delivered packages, the delivery robot docks with the service cabin, and the service cabin transfers the packages to the robot for delivery. The above technical solutions each have unsolvable problems, for example, high labor cost, low delivery efficiency, too long waiting time of deliveryman, too long waiting time of robot, tedious storage and transfer process, complex and expensive transfer mechanism, large occupation area of service cabin and high requirements for location and the like.

In view of the above problems, in this embodiment, there is provided a delivery apparatus. In this apparatus, a movable chassis and cabin which are detachably and electrically connected are employed, and the movable chassis is controlled to drive the cabin to move to a target position, leave the cabin and re-accept the cabin. In the above technical solution, a delivery apparatus can be obtained by using the movable chassis and the cabin which can be combined freely to handle various delivery situations so as to complete delivery tasks, thus greatly improving the delivery efficiency, and lowering the delivery costs. In this way, the flexibility of delivery task scheduling can be improved, the occupation area for performing delivery tasks is reduced, and the cases in which the deliveryman waits for the delivery robot for too long and the robot waits for a user for too long can be avoided.

In some examples, the preset delivery condition may include one or more of the following conditions: the accommodation space of the cabin is fully loaded with to-be-delivered objects, and the accommodation space of the cabin is loaded with at least one to-be-delivered object for a loading time length exceeding a first preset time length threshold. When a cabin satisfies the above preset delivery condition, it is thought that delivery can be performed. Then, one movable chassis capable of performing the delivery task may be determined to accept the cabin, where the movable chassis capable of performing the delivery task may be, for example, a movable chassis in an idle state and the like.

In some examples, the to-be-delivered object refers to an object to be delivered to a position or location, such as a product and a commodity.

In some examples, after the movable chassis capable of performing the delivery task is determined, an accept command may be sent to the movable chassis to enable it to move to the support space of the cabin and lift the lifting component to move the cabin away from the ground to form a delivery apparatus. The accept command carries unique identification information of the target cabin and delivery task information, the unique identification information of the target cabin is used to enable the movable chassis to confirm the cabin to accept, and the delivery task information at least includes one or more of the following information: target position, information of a to-be-delivered object, reception information and the like. According to the delivery task information, the movable chassis may obtain a target position and determine a travel path.

In some examples, after a successful accept message is received from the movable chassis, a delivery command may be sent to the movable chassis to enable the movable chassis to, based on the delivery task information, especially target position information in the delivery task information, drive the target cabin to move to the target position, thus completing delivery.

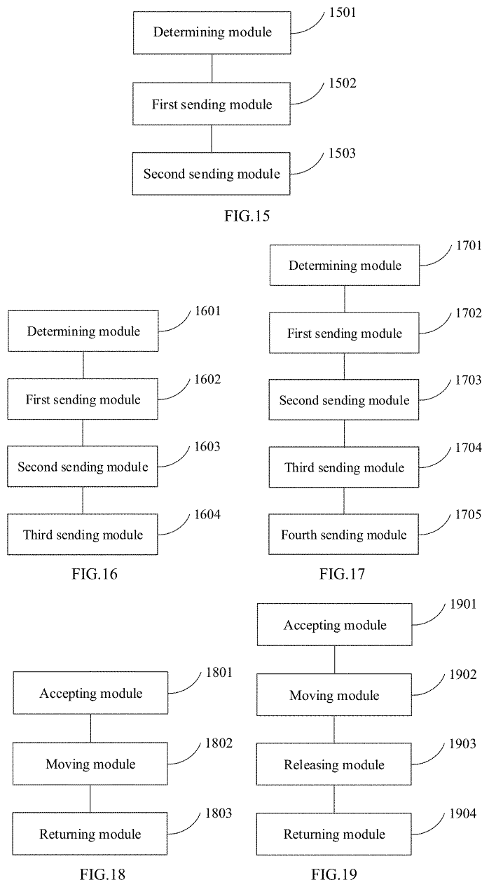

In some examples, the apparatus further includes: in response to detecting a time length in which the movable chassis waits at the target position exceeds a first preset time length threshold, sending a release and return command to the movable chassis to enable the movable chassis to release a connection with the target cabin to leave the target cabin at the target position and return to the taking position of the to-be-delivered objects. As shown in FIG. 16, the delivery apparatus includes:

a determining module 1601, configured to, in response to detecting a target cabin satisfies a preset delivery condition, determine a movable chassis capable of performing a delivery task, where the target cabin is loaded with one or more to-be-delivered objects;

a first sending module 1602, configured to send an accept command to the movable chassis to enable the movable chassis to accept the target cabin, where the accept command carries unique identification information of the target cabin and delivery task information;

a second sending module 1603, configured to, in response to receiving a successful accept message from the movable chassis, send a delivery command to the movable chassis to enable the movable chassis to drive the target cabin to move to a target position based on the delivery task information;

a third sending module 1604, configured to, in response to detecting a time length in which the movable chassis waits at the target position exceeds a first preset time length threshold, send a release and return command to the movable chassis to enable the movable chassis to release a connection with the target cabin to leave the target cabin at the target position and return to a taking position of the to-be-delivered objects.

Considering that after the movable chassis reaches the target position, it is possible that a user cannot take out the to-be-delivered object in time because the user is at a meeting or telephone is unavailable or the like. In order to save the delivery time and improve the delivery efficiency, in this implementation, if it is detected that the time length in which the movable chassis waits at the target position exceeds the first preset time length threshold, it is thought that it is no need to wait for any more time. In this case, a release and return command is sent to the movable chassis to enable the movable chassis to release a connection with the target cabin to leave the target cabin at the target position to wait for the user to take the to-be-delivered object and enable the movable chassis to return to the taking position of the to-be-delivered objects to continue accepting other cabins to perform other delivery tasks.

In some examples, the apparatus further includes: in response to detecting that the to-be-delivered objects in the target cabin left at the target position are all taken out, determining a movable chassis capable of performing an accept task and sending a return and accept command to the movable chassis to enable the movable chassis to return to the target position to accept the target cabin and transport and place the target cabin at the taking position of the to-be-delivered objects. As shown in FIG. 17, the delivery apparatus includes:

a determining module 1701, configured to, in response to detecting a target cabin satisfies a preset delivery condition, determine a movable chassis capable of performing a delivery task, where the target cabin is loaded with one or more to-be-delivered objects;

a first sending module 1702, configured to send an accept command to the movable chassis to enable the movable chassis to accept the target cabin, where the accept command carries unique identification information of the target cabin and delivery task information;

a second sending module 1703, configured to, in response to receiving a successful accept message from the movable chassis, send a delivery command to the movable chassis to enable the movable chassis to drive the target cabin to move to a target position based on the delivery task information;

a third sending module 1704, configured to, in response to detecting a time length in which the movable chassis waits at the target position exceeds a first preset time length threshold, send a release and return command to the movable chassis to enable the movable chassis to release a connection with the target cabin to leave the target cabin at the target position and return to a taking position of the to-be-delivered objects;

a fourth sending module 1705, configured to, in response to detecting that the to-be-delivered objects in the target cabin left at the target position are all taken out, determine a movable chassis capable of performing an accept task and send a return and accept command to the movable chassis to enable the movable chassis to return to the target position to accept the target cabin and transport and place the target cabin at the taking position of the to-be-delivered objects.

After the target cabin is left at the target position, in order to call back the cabin in an idle state to continue accommodating to-be-delivered objects in time, in this implementation, when it is detected that the to-be-delivered objects in the target cabin left at the target position are all taken out, a movable chassis capable of performing a cabin accept task at this time is determined. A return and accept command is sent to the movable chassis to enable the movable chassis to move to the target position to accept the target cabin and carry back and place the target cabin at the taking position of the to-be-delivered objects. The movable chassis capable of performing the cabin accept task may be the movable chassis which previously transports the target cabin to the target position, or another movable chassis in an idle state.

FIG. 18 is a structural block diagram illustrating an apparatus for performing delivery using the above delivery system according to another embodiment of the present disclosure. The apparatus may be implemented as a movable chassis. As shown in FIG. 18, the delivery apparatus includes:

an accepting module 1801, configured to, in response to receiving an accept command from a server, accept a target cabin at a taking position of to-be-delivered objects and send a successful accept message to the server, where the accept command carries unique identification information of the target cabin and delivery task information, and the target cabin is loaded with one or more to-be-delivered objects;

a moving module 1802, configured to, in response to receiving a delivery command from the server, drive the target cabin to move to a target position based on the delivery task information;

a returning module 1803, configured to, in response to detecting that the to-be-delivered objects are all already taken out, drive the target cabin to return to the taking position of the to-be-delivered objects.

As mentioned above, along with development of internet technologies, more and more merchants or service providers provide services to users through internet platforms, and many internet services need to be delivered by deliverymen. Therefore, delivery efficiency is very important for improvement of service quality of the internet platforms. In the related arts, there exist the following several solutions: a deliveryman is scheduled based on application program to complete delivery of packages by human labor; a delivery robot is employed to deliver packages at a delivery location; an intelligent transfer service cabin is disposed to temporarily store to-be-delivered packages, the delivery robot docks with the service cabin, and the service cabin transfers the packages to the robot for delivery. The above technical solutions each have unsolvable problems, for example, high labor cost, low delivery efficiency, too long waiting time of deliveryman, too long waiting time of robot, tedious storage and transfer process, complex and expensive transfer mechanism, large occupation area of service cabin and high requirements for location and the like.

In view of the above problems, in this embodiment, a delivery apparatus is provided. The apparatus uses a detachable and electrical connection of the movable chassis with the cabin to, based on a received instruction, drive the cabin to move to a target position, leave the cabin and re-accept the cabin. In the above technical solution, a delivery apparatus can be obtained by using the movable chassis and the cabin which can be combined freely to handle various delivery situations so as to complete delivery tasks, thus greatly improving the delivery efficiency, and lowering the delivery costs. In this way, the flexibility of delivery task scheduling can be improved, the occupation area for performing delivery tasks is reduced, and the cases in which the deliveryman waits for the delivery robot for too long and the robot waits for a user for too long can be avoided.

In some examples, the to-be-delivered object refers to an object to be delivered to a position or location, such as a product and a commodity.

In some examples, after the movable chassis receives an accept command sent by the server based on a deliverable state of the cabin, the movable chassis may accept the target cabin at the taking position of the to-be-delivered objects, dock with the target cabin successfully and then sends a successful accept message to the server. The accept command carries unique identification information of the target cabin and delivery task information, the target cabin is loaded with one or more to-be-delivered objects. The unique identification information of the target cabin is used to enable the movable chassis to confirm the cabin to accept, and the delivery task information at least includes one or more of the following information: target position, information of a to-be-delivered object, reception information and the like. According to the delivery task information, the movable chassis may obtain a target position and determine a travel path.

In some examples, after the movable chassis successfully accepts the target cabin and receives a delivery command from the server, the movable chassis may, based on the delivery task information, especially target position information in the delivery task information, drive the target cabin to move to the target position, thus completing delivery.

In some examples, after it is detected that all to-be-delivered objects are taken out, the target cabin in an idle state is driven to return to the taking position of the to-be-delivered objects to continue accommodating other to-be-delivered objects.

In some examples, the apparatus may, in addition to the moving module 1802, further include: in response to receiving a release and return command from the server, releasing a connection with the target cabin to leave the target cabin at the target position and returning to the taking position of the to-be-delivered objects. In this implementation, the returning module 1803 may be configured to: in response to receiving a return and accept command from the server, move to the target position to accept the target cabin left at the target position and transport and place the target cabin at the taking position of the to-be-delivered objects. As shown in FIG. 19, the delivery apparatus includes:

an accepting module 1901, configured to, in response to receiving an accept command from a server, accept a target cabin at a taking position of to-be-delivered objects and send a successful accept message to the server, where the accept command carries unique identification information of the target cabin and delivery task information, and the target cabin is loaded with one or more to-be-delivered objects;

a moving module 1902, configured to, in response to receiving a delivery command from the server, drive the target cabin to move to a target position based on the delivery task information;

a releasing module 1903, configured to, in response to receiving a release and return command from the server, release a connection with the target cabin to leave the target cabin at the target position and return to the taking position of the to-be-delivered objects;

a returning module 1904, configured to, in response to receiving a return and accept command from the server, move to the target position to accept the target cabin left at the target position and transport and place the target cabin at the taking position of the to-be-delivered objects.

Considering that after the movable chassis reaches the target position, it is possible that a user cannot take out the to-be-delivered object in time because the user is at a meeting or telephone is unavailable or the like. In order to save the delivery time and improve the delivery efficiency, in this implementation, if it is detected that the time length in which the movable chassis waits at the target position exceeds the first preset time length threshold, it is thought that it is no need to wait for any more time. In this case, the server may send a release and return command to the movable chassis, and the movable chassis receives the release and return command and then releases a connection with the target cabin to leave the target cabin at the target position to wait for the user to take the to-be-delivered object and the movable chassis returns alone to the taking position of the to-be-delivered objects to continue accepting other cabins satisfying the delivery condition. Afterwards, after all to-be-delivered objects in the target cabin are taken out and the movable chassis receives a return and accept command from the server, the movable chassis may move to the target position to accept the target cabin left at the target position and transport and place the target cabin at the taking position of the to-be-delivered objects to enable it to continue accommodating other to-be-delivered objects.

In the above implementation, in order to further improve the delivery efficiency, the reception addresses corresponding to the to-be-delivered objects loaded into a same cabin are same or similar.

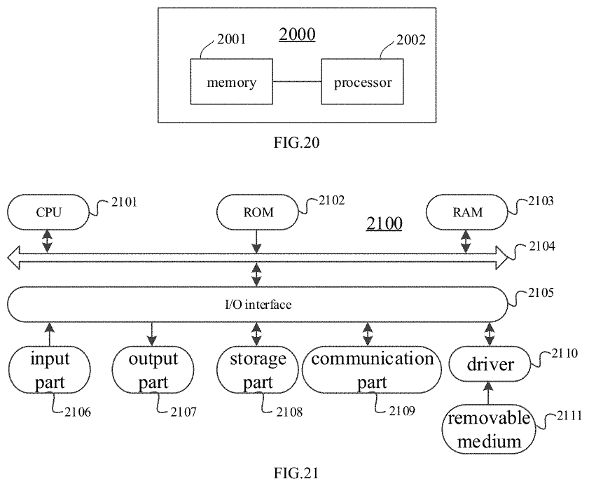

The present disclosure further provides an electronic device. FIG. 20 is a structural block diagram illustrating an electronic device according to an embodiment of the present disclosure. As shown in FIG. 20, the electronic device 2000 includes a memory 2001 and a processor 2002, where the memory 2001 is configured to store one or more computer instructions which are executed by the processor 2002 to implement the above method steps.

FIG. 21 is a schematic structural diagram illustrating a computer system suitable for implementing the delivery method of the embodiments of the present disclosure. As shown in FIG. 21, the computer system 2100 includes a central processing unit (CPU) 2101 which may execute various processings in the above embodiments according to a program stored in a Read Only Memory (ROM) 2102 or a program loaded from a storage part 2108 to a Random Access Memory (RAM) 2103. The RAM 2103 further stores various programs and data required to operate the system 2100. CPU2101, ROM2102 and RAM2103 are mutually connected via a bus 2104. An input/output (I/O) interface 2105 is also connected to the bus 2104. The following components are connected to I/O interface 2105: input part 2106 such as a keyboard and a mouse; a cathode ray tube (CRT), a liquid crystal display (LCD) and the like, and an output part 2107 such as a loudspeaker; a storage part 2108 such as a hard disk; a communication part 2109 of a network interface card including such as an LAN card, and a modem and the like. The communication part 2109 performs communication processing via a network such as an internet. A driver 2110 also needs to be connected to the I/O interface 2105. A removable medium 2111 such as a magnetic disk, a compact disk, a magneto-optical disk, a semiconductor storage device, may be installed on the driver 2110 as required, so that the computer programs read from the driver 2110 may be installed on the storage part 2108 as required. Particularly, in an embodiment of the present disclosure, the above method may be implemented as a computer software program. For example, the embodiment of the present disclosure includes a computer program product, including computer programs tangibly contained on its readable medium. The computer program includes program codes for performing the above delivery method. In such embodiments, the computer program may be loaded and installed from a network through the communication part 2109, and/or installed from the removable medium 2111.

The flowcharts and block diagrams in the accompanying drawings show possible implementations of the system architectures, functions and operations of systems, methods and computer program products of various embodiments of the present disclosure. In this point, each block in the flowcharts or block diagrams may represent one module, program segment or part of codes, which may include one or more executable instructions for implementing the specified logic functions. It also should be noted that in some alternative implementations, the functions marked in the blocks may also be performed in a sequence different from that marked in the accompanying drawings. For example, two continuously-represented blocks can be basically performed in parallel or sometimes may be performed in a reverse sequence depending on functions involved. It is also noted that each block in block diagrams and/or flowcharts and combinations of blocks of block diagrams and/or flowcharts may be implemented by a dedicated hardware-based system for performing specified functions or operations, or by combination of dedicated hardware and computer instructions.

Units or modules involved in the descriptions of the embodiments of the present disclosure may be implemented by software, or hardware. The described units or modules may also be disposed in a processor and the names of these units and modules do not constitute any limitation to the units or modules themselves in some circumstances.

As another aspect, the present disclosure further provides a computer readable storage medium. The computer readable storage medium may be a computer readable storage medium involved in the apparatus of the embodiments of the present disclosure, or a computer readable storage medium present separately and unassembled into devices. The computer readable storage medium stores one or more programs which are executed by one or more processors to implement the method described in the present disclosure.

The above descriptions are merely made to the preferred embodiments of the present disclosure and the technical principles employed. Those skilled in the art should understand that the scope of the present disclosure is not limited to the technical solutions formed by specific combinations of the above technical features, and should also cover other technical solutions formed by any combinations of the above technical features or equivalent technical features without departing from the inventive thought, for example, those technical solutions formed by mutual replacement of the above features and the technical features having similar functions provided in (not limited to) the present disclosure.

What is claimed is:

1. A delivery apparatus, comprising:
a movable chassis detachably and electrically connected with a cabin, wherein the movable chassis is configured to comprise:
a first controller mounted inside the movable chassis, and
a moving component mounted at a bottom of the movable chassis and connected with the first controller to drive the movable chassis and the cabin to move to a target position according to an instruction of the first controller;
the cabin configured to have one or more accommodation spaces for accommodating to-be-delivered objects.

2. The delivery apparatus of claim 1, wherein the movable chassis further comprises:
a chassis body;
a lifting component mounted inside the chassis body and capable of moving up and down along a longitudinal direction, wherein a lifting platform is disposed on a top of the lifting component;
a first electric connection component mounted on the lifting platform to establish an electrical connection between the movable chassis and the cabin;
wherein the moving component is mounted at a bottom of the chassis body; and
the first controller is mounted inside the chassis body and connected with the first electric connection component, the moving component and the lifting component to control the first electric connection component, the moving component and the lifting component.

3. The delivery apparatus of claim 2, wherein the movable chassis further comprises:
a first positioning component, mounted on the lifting platform and configured to fix a relative position between the movable chassis and the cabin; and
a first locking component, mounted on the lifting platform and configured to lock up a connection between the movable chassis and the cabin.

4. The delivery apparatus of claim 3, wherein the cabin comprises:
a cabin body, provided with one or more accommodation spaces for accommodating to-be-delivered objects;
a support component, mounted at a bottom of the cabin body to support the cabin and configured to form an accommodation space to accommodate the movable chassis; and
a second electric connection component, mounted at the bottom of the cabin body to cooperate with the first electric connection component to establish the electrical connection between the cabin and the movable chassis.

5. The delivery apparatus of claim 4, wherein the cabin further comprises:
a second positioning component, mounted at the bottom of the cabin body and configured to cooperate with the first positioning component to fix the relative position between the cabin and the movable chassis;
a second locking component, mounted at the bottom of the cabin body and configured to cooperate with the first locking component to lock up the connection between the cabin and the movable chassis;
a second controller, mounted inside the cabin body and connected with the second electric connection component, the second positioning component and the second locking component to detect a cabin state and send the detected cabin state to a server.

6. A delivery system, comprising one or more movable chassis, one or more cabins and a processor,
wherein the cabin is placed at a taking position of to-be-delivered objects to accommodate the to-be-delivered objects;
the movable chassis is configured to, according to an instruction of the processor, accept a corresponding cabin to drive the cabin to move to a target position, so as to complete delivery of the to-be-delivered objects.

7. The delivery system of claim 6, wherein the movable chassis is detachably and electrically connected with the cabin.

8. The delivery system of claim 6 or 7, wherein the movable chassis comprises:
a first controller, mounted inside the movable chassis, and
a moving component, mounted at a bottom of the movable chassis and connected with the first controller to drive the movable chassis and the cabin to move to a target position according to an instruction of the first controller;
the cabin has one or more accommodation spaces for accommodating the to-be-delivered objects.

9. The delivery system of claim 8, wherein the movable chassis further comprises;
a chassis body;
a lifting component, mounted inside the chassis body and capable of moving up and down along a longitudinal direction, wherein a lifting platform is disposed on a top of the lifting component; and
a first electric connection component, mounted on the lifting platform to establish an electrical connection between the movable chassis and the cabin;
wherein the moving component is mounted at a bottom of the chassis body; and
the first controller is mounted inside the chassis body and connected with the first electric connection component, the moving component and the lifting component to control the first electric connection component, the moving component and the lifting component.

10. The delivery system of claim 9, wherein the movable chassis further comprises:
a first positioning component, mounted on the lifting platform and configured to fix a relative position between the movable chassis and the cabin; and
a first locking component, mounted on the lifting platform and configured to lock up a connection between the movable chassis and the cabin.

11. The delivery system of claim 10, wherein the cabin comprises;
a cabin body, provided with one or more accommodation spaces for accommodating to-be-delivered objects;
a support component, mounted at a bottom of the cabin body to support the cabin and configured to form an accommodation space to accommodate the movable chassis; and
a second electric connection component, mounted at the bottom of the cabin body to cooperate with the first electric connection component to establish an electrical connection between the cabin and the movable chassis.

12. The delivery system of claim 11, wherein the cabin further comprises:
a second positioning component, mounted at the bottom of the cabin body and configured to cooperate with the first positioning component to fix the relative position between the cabin and the movable chassis;
a second locking component, mounted at the bottom of the cabin body and configured to cooperate with the first locking component to lock up the connection between the cabin and the movable chassis; and
a second controller, mounted inside the cabin body and connected with the second electric connection component, the second positioning component and the second locking component to detect a cabin state and send the detected cabin state to a server.

13. A method of performing delivery using the delivery system according to claim 6, comprising:
in response to detecting a target cabin satisfies a preset delivery condition, determining a movable chassis capable of performing a delivery task, wherein the target cabin is loaded with one or more to-be-delivered objects;
sending an accept command to the movable chassis to enable the movable chassis to accept the target cabin, wherein the accept command carries unique identification information of the target cabin and delivery task information;
in response to receiving a successful accept message from the movable chassis, sending a delivery command to the movable chassis to enable the movable chassis to drive the target cabin to move to a target position based on the delivery task information.

14. The method of claim 13, further comprising:
in response to detecting a time length in which the movable chassis waits at the target position exceeds a first preset time length threshold, sending a release and return command to the movable chassis to enable the movable chassis to release a connection with the target cabin to leave the target cabin at the target position and return to a taking position of the to-be-delivered objects.

15. The method of claim 14, further comprising:
in response to detecting that the to-be-delivered objects in the target cabin left at the target position are all taken out, determining a movable chassis capable of performing an accept task and sending a return and accept command to the movable chassis to enable the movable chassis to return to the target position to accept the target cabin and transport and place the target cabin at the taking position of the to-be-delivered objects.

16. A method of performing delivery using the delivery system according to claim 6, comprising:
in response to receiving an accept command from a server, accepting a target cabin at a taking position of to-be-delivered objects and sending a successful accept message to the server, wherein the accept command carries unique identification information of the target cabin and delivery task information, and the target cabin is loaded with one or more to-be-delivered objects;
in response to receiving a delivery command from the server, driving the target cabin to move to a target position based on the delivery task information;
in response to detecting that the to-be-delivered objects are all already taken out, driving the target cabin to return to the taking position of the to-be-delivered objects.

17. The method of claim 16, wherein after in response to receiving the delivery command from the server, driving the target cabin to move to the target position based on the delivery task information, the method further comprises:
in response to receiving a release and return command from the server, releasing a connection with the target cabin to leave the target cabin at the target position and returning to the taking position of the to-be-delivered objects.

18. The method of claim 17, wherein in response to detecting that the to-be-delivered objects are all already taken out, driving the target cabin to return to the taking position of the to-be-delivered objects is implemented by:
in response to receiving a return and accept command from the server, moving to the target position to accept the target cabin left at the target position and transporting and placing the target cabin at the taking position of the to-be-delivered objects.

19-24. (canceled)

25. An electronic device, comprising a memory and a processor, wherein the memory is configured to store one or more computer instructions, wherein the one or more computer instructions are executed by the processor to implement the steps of the method according to claim 13.

26. A computer readable storage medium, storing computer instructions thereon, wherein the computer instructions are executed by a processor to implement the steps of the method according to claim 13.
